(19) United States
(12) Patent Application Publication
(10) Pub. No.: US 2007/0057224 A1
(43) Pub. Date: Mar. 15, 2007

(54) Composition for cooling and simultaneous filtration of the gas-aerosol fire-extinguishing mixture

(75) Inventors: Dmitriy Leonidovich Rusin, Moscow (RU); Anatoliy Petrovich Denisyuk, Moscow (RU)

Correspondence Address: ROTHWELL, FIGG, ERNST & MANBECK, P.C., 1425 K STREET, N.W., SUITE 800, WASHINGTON, DC, 20005, US

(73) Assignee: R-Amtech International, Inc., Bellevue, WA (US)

(21) Appl. No.: 10/570,625

(22) PCT Filed: Sep. 3, 2004
(86) PCT No.: PCT/RU04/00342

§ 371 Date: Mar. 3, 2006

(30) Foreign Application Priority Data
Sep. 5, 2003 (RU) 2003127009

(51) Int. Cl. A62D 1/00

(52) U.S. Cl. 252/2

(57) ABSTRACT

The invention relates to compositions for cooling and simultaneous filtration of the gas-aerosol fire-extinguishing mixture that is formed during burning of pyrotechnical charges in generators. In this composition, basic magnesium carbonate and/or carbonates of group I and II metals are used as the heat-absorbing fillers; nitrate, potassium perchlorate or mixtures thereof are used as the oxidizer; graphite, sodium stearate or mixtures thereof are used as the production process additives; additionally, potassium chloride, alkali metal silicate of the general formula Me2O.mSiO2, where Me is potassium or sodium, m is the silicate variable in the amount of 2.1-3.8 or a mixtures thereof are used as the inorganic binder; the sorbent selected from the series of zeolites, silica gels or mixtures thereof. The tablets, granules produced from the composition have high levels of strength and efficiency of cooling the gas-aerosol compounds which is formed during burning of the pyrotechnical charge at high speed 5-12 mm/sec and high combustion temperatures ˜1500 deg C.

### CROSS-REFERENCE TO RELATED APPLICATION

This application is National Phase of International Application Serial No. PCT/RU2004/000342, filed Sep. 3, 2004.

### BACKGROUND OF THE INVENTION

1. Field of Invention

This invention relates to the field of fire-fighting equipment, specifically to means for cooling and filtration of a gas-aerosol fire-extinguishing mixture (GAFEM) that is formed during burning of pyrotechnical charges in the generator.

Cooling and filtration are steps in the process of formation of GAFEM and are aimed to enhance the GAFEM efficiency by means of decreasing the temperature and toxicity. As a result, the field of use of aerosol generators is extended considerably, in particular, to different structures and spaces without harmful effect on human body.

2. Description of Background Art

Cooling and simultaneous filtration of GAFEM is a promising direction in the GAFEM formation. According to RU 2142306, Oct. 12,1999, these processes are accomplished through the interaction of GAFEM with compounds characterized by high heat-absorbing capacity, selected from the group of aluminisolicates, e.g. zeolites, silica gels or mixtures thereof.

In RU 2142835, Dec. 20, 1999 the cooling is achieved by passing GAFEM through a metal heat exchanger; subsequently additional cooling and simultaneous filtration are realized by passing the GAFEM through a filtering sorbent selected from the group consisting of zeolites, silica gels, activated carbon or mixtures thereof. The filtering sorbent can additionally contain on its surface carbonates or alkali metal hydrates.

The above inventions have several significant shortcomings—they cannot be used in aerosol generators with pyrotechnical charges having high (over 1000 deg C.) combustion temperature and high (over 3 mm/sec) speed of burning. The reason is that at temperatures above 800 deg. C., zeolite, silica gel granules experience strong thermal fluctuations and eventually break down. The result is that the sorbent filtering efficiency drops to zero. Furthermore, broken loose incandescent particles fly out of the generator outlet and can be the cause of re-ignition or even a fire in the event of false operation of the generator. In some generators (e.g. with reverse discharge of GAFEM) broken particles of the sorbent (especially at high velocities of the charge, 7-8 mm/sec) exert pronounced dynamic resistance to the GAFEM flow, which can lead to the explosion of the generator. This poses the problem of binding individual granules of the zeolites, silica gels into larger aggregates (tablets) by using special binders.

Assessing inherent heat-absorbing capacity of zeolites, silica gels, it should be noted that it is not higher than that of hydrates, hydrooxides, oxalates of group I and II metals, formed with the use of special additives and pressed into tablets.

A known composition for cooling the fire-extinguishing aerosol (RU 2086278, Oct. 8, 1997) was formed from nitrocellulose, plasticizers, stabilizers, catalysts, production process additives and a heat-absorbing filler: basic magnesium carbonate or ammonium oxalate, or basic magnesium phosphate in the amount of 25-45% by mass.

This composition has several shortcomings:
low coefficient of efficiency of coolong GAFEM at the outlet of the generator (Cec is equal to the ratio of the combustion temperature of the pyrotechnical charge to the GAFEM temperature at the outlet of the generator containing the coolant). In this case, Cec is 1900/380=5.0. A relatively low cooling efficiency is due to the fact that the heat-absorbing filler accounts for not more than 45% by mass of the composition. It is impossible to increase the filler content on account of the operation problems during production;
low strength levels (0.60-0.69 MPa) of the tablets formed during the production of the composition. This factor imposes restrictions on transportation conditions for tablets and finished generators, as well as on their operation under vibrational overloads in transport vehicles;
high levels of toxic gases evolving on exposure of the composition to high temperatures, such as CO3, NO3, NH3, HCN, which are formed on the decomposition of nitrocellulose, plasticizers, stabilizers and other components.

A composition for cooling the fire-extinguishing aerosol is known (RU 2120318, Oct. 20, 1998) which contains as a binder carboxy-methylcellulose and/or polyvinylaceftate, or polyvinyl alcohol, production process additives (kaolin, sodium or zinc stearate, industrial or instrumental oil) and a heat-absorbing fille r-basic magnesium carbonate or ammonium oxalate, basic magnesium phosphate in the amount of 25-45% by mass.

However this composition has the following shortcomings:
low strength level ( 0.63-0.75 MPa) of the tablets formed during the production of the composition;
low coefficient of efficiency of the GAFEM cooling (Cec-1900/325=5.84);
high level of toxicity due to high concentration of gases such as CO, NH3 which are released on exposure of composition components to high temperatures.

The most close analog with respect to the set of important characteristics is the cooling composition for gas generators protected by patent RU 2166975, May 20, 2001.

This cooling composition contains in percent by mass the following components: 20-60 magnesium hydroxide and/or basic magnesium carbonate; 10-20 boric acid; and the remainder—carbonates of group I or II metals. Metal carbonates used included sodium carbonate, magnesium or calcium carbonate. The cooling composition can also contain, % by mass, sodium bicarbonate—10-55; magnesium oxide—10-40; hydrated calcium sulphate—10-25, as well as catalysts: oxides of metals of transition valency (CuO, MnO2)—10-30. The cooling composition can further contain oxidizers 10-45, % by mass, such as nitrates, perchlorates, permanganates, alkali metal chromates or percarbonates, or peroxides of alkali-earth metals. The cooling composition contains production process additives in the amount of 0.5-3.0% by mass, selected from the series of alkali metal stearates, or alkali-earth metal stearates, or carboxy methyl cellulose, or methylcellulose, or gelatin.

The coefficient of cooling efficiency is, on average, 1350/210=6.42. The average concentration of carbon oxide at the generator outlet is 0.7-2.2 percent by volume. Tablets formed from this cooling composition have compression strength of 04.-2.1 Mpa. This cooling composition has he following disadvantages:
low coefficient of efficiency of the GAFEM cooling at the generator outlet. This is due to the fact that the cooling composition comprises boric acid which has a relatively low melting point (170.9 deg C.) and acts as a cementing agent. During the operation of the generator, under the action of high temperatures (1250-1350 deg. C.) boric acid undergoes melting within a short span of time, to cause the tablets to break down; the coolant components stick together and their surface gets clogged up with the products of desintegration and melting;
low level of the GAFEM environmental safety due to a high concentration of toxic gases at the output of the generator;
inadequate strength of the tablets formed from the composition limits service life of generators under vibratory loads and momentary temperature fluctuations. This occurs because boric acid used as a binder undergoes plastic deformation on exposure to high temperatures.

All known analogs including the closest one do not ensure high fire-extinguishing efficiency (which needs a greater proportion of the most active fire-extinguishing particles of the aeroso 1-2 mcm in size); high efficiency of the GAFEM cooling; better environmental safety which can be achieved through the absorption of noxious gases, and the enhanced levels of the strength characteristics of the articles formed from the composition—tablets; granules.

### SUMMARY OF THE INVENTION

The objective of the proposed invention has been to create a composition for cooling and simultaneous filtration of the gas-aerosol fire-extinguishing mixture which would make it possible to obtain a one-step solution of the following tasks:
enhancing the efficiency of the GAFEM cooling at the output of the generator by increasing the content of the heat-absorbing filler of the composition to 90% by mass;
enhancing the fire-extinguishing efficiency of the composition by increasing the proportion of the most active, 1-2 mcm in size, fire-extinguishing particles of the aerosol due to filtering the aerosol;
enhancing the levels of the strength characteristics of tablets, granules formed from the composition owing to the use of a new set of components, comprising the inorganic binder, heat-absorbing filler, oxidizer, sorbent and production process additives;
enhancing the GAFEM environmental safety by using a sorbent capable of sorbing noxious gases.

The proposed composition for cooling and simultaneous filtration of the gas-aerosol fire-extinguishing mixture contains:
as a heat-absorbing filler—basic carbonate of magnesium and/or carbonates of group I or II metals in the amount of 25-90% by mass;
an oxidizer—nitrate, potassium perchlorate or a mixture thereof in the amount of 1-10% by mass;
production process additives—graphite, sodium or calcium stearate or a mixture thereof in the amount of 0.2-1.5% by mass.

As an inorganic binder—potassium chloride, alkali metal silicate of the general formula Me2O. mSiO2, where Me is potassium or sodium, m −2.1 −3.8 or a mixture thereof in the amount of 5-10% by mass;

The sorbent is the remainder. Preferably, the sorbent is selected from the group consisting of zeolites, silica gels or a mixture thereof.

Out of the claimed wide range of component concentrations, their actual ratios are determined based on the technological balance and functional applicability considerations.

### DETAILED DESCRIPTION OF THE INVENTION

A comparative analysis of the claimed composition for cooling and simultaneous filtration of the GAFEM with its closes analogues revealed its following distinguishing characteristics:

a) the inorganic binder: potassium chloride, alkali metal silicate of the general formula Me2O.mSiO2, where M is potassium or sodium, m is the silicate component equal to 2.1-3.8, or a mixture thereof.

The application of such inorganic binders in compositions for cooling and simultaneous filtration of GAFEM has not been known previously.

The use of the selected inorganic binder comprising potassium chloride with high heat resistance (KCl m.p. −771 deg C.) and alkali metal silicates which do not decompose up to 1400 deg C., makes it possible to obtain target technological properties while achieving high levels of the composition filling, and to produce high-strength articles ( tablet, granules).

b) the sorbent preferably selected from the group of zeolites, silica gels or a mixture thereof, on exposure to high combustion temperatures of the pyrotechnical composition (over 1500 deg C.) forms slag with the porous structure. Hence the sorbent performs in one step the filtration of aerosol particles and adsorption of noxious gases.

During combustion of the pyrotechnical composition, the hot GAFEM heats the surface of the tablet, causing thereby the decomposition of the oxidizer and the release of oxygen which oxidizers underoxidized gaseous components of the GAFEM, as well as the decomposition of the heat-absorbong filler. Simultaneously, the silica gel and zeolite granules cake with one another and with other particles (KCl, K2CO3, K2), KHCO3) to produce porous slag with filtering properties.

The use of sorbents which form porous slag structures in the compositions intended for GAFEM cooling and filtration has not been described previously nor is it obvious. For example, upon introducing the selected sorbents of this invention into the prototype composition its efficiency to absorb toxic gases and to filter out aerosol solid particles will decrease to zero because the boric acid of the GAFEM undergoes melting at high temperatures and clogs the pores.

c) a new set of the components: the heat-absorbing filler (basic magnesium carbonate and/or carbonates of group I or group II metals), oxidizer (nitrate, potassium perchlorate or a mixture thereof), production process additives ( graphite, sodium stearate or potassium stearate or a mixture thereof), inorganic binder (potassium chloride, alkali metal silicate of the general formula Me2O.mSiO2, where Me is potassium or sodium, m is the silicate component of 2.1-3.8, or a mixture thereof); sorbent (preferably selected from the group of zeolites, silica gels or mixtures thereof).

The proposed composition for cooling and filtration of GAFEM makes it possible to achieve at the same time: the GAFEM cooling at the expense of endothermal decomposition of the heat-absorbing filler; filtration of aerosol particles which will increase the share of 1-2 mcm particles at the output of the generator due to the formation of a slaggy porous structure as the tablets heat up; adsorption of noxious gases and final oxidation of the gases on the sorbent surface by the oxygen released from the decomposed oxidizer; it is also possible to enhance the strength of tablets, granules owing to this new set of the components.

### PREFERRED EMBODIMENTS OF THE INVENTION

### EXAMPLE 1

To prepare 1 kg of the composition it is necessary to charge a paddle mixer with the following components: 800 g of basic magnesium carbonate (3MgCO3.Mg(OH)2.3H2O), 50 g of sodium carbonate Na2CO3, 50 g of magnesium carbonate MgCO3 with particle size 15-80 mcm, 5 g of potassium nitrate; 5 g of potassium perchlorate KClO4 with particle size 5-10 mcm; 5 g of graphite; 5 g of sodium stearate; 60 g of inorganic binder KCl; 20 g of zeolies. The mixture is stirred for 40 minutes.

The resulting mixture is placed in the rotary press to obtain tablets 8 mm in diameter and 5 mm high by the blind-die pressing method at pressure 200 MPa. The ready tablets are tested for compression strength.

The produced tablets are loaded into the generator which comprises the metal housing, the unit with the pyrotechnocal charge and ignitor, the combustion chamber, the cooling and filtration unit and the outlet unit. The pyrotechnical composition consists of a pyrotecnical aerosol-forming fire-extinguishing composition with the burning temperature 1500 deg C.; the starting components are taken in the following ratios, % by mass:
Potassium nitrate 64
Potassium perchlorate 20
Phenol-formaldehyde resin 11.1
Dibutyl phthalate 2.5
Calcium srearate 0.4
Polytetrafluorethylene (PTFE) −2.0

The generator is started in the test unit. The GAFEM temperature is measured 20 cm from the cut using the chromel-alumel thermocouple and a recorder. The mass fraction of 1-2 mcm particles of the aerosol disperse phase is determined by sampling under the microscope and subsequent weighing.

The toxic content of the GAFEM is determined by taking samples from the gas ducts located in the middle part of the test unit.

To determine the carbon oxide content, a gas sample is taken with a gas burette fitted with the hydraulic seal and then analyzed on the gas chromatograph equipped with a thermal conductivity detector. The parameters of the packed glass chromatographic column are 2.4 m long; 2.5 inside diameter, the feed rate of the carrier gas ( helium) is 30 c,3/min, the column temperature 32 deg C.; sample volume 1 m3; chromatograms are recorded with TC-1601 recorder. The results of the gas concentration measurements are obtained as percent by volume and recalculated to milligrams per cubic meter for the following conditions: pressure 760 m/Hg, temperature 293 deg K (20 deg C.) (the lower limit of measurements is 0.001 by volume, which corresponds to the concentration 11 mg/m3 and pressure 1 Pa=750 mm/H).

To determine the ammonium, nitrogen oxide and cyanide contents, the GAFEM gas phase is bubbled through a water-filled trap fitted with the glass filter; the rate of bubbling 2 l/min, for 10 min.

The ammonium content is determined by photocolorimetry on the reaction product of the GAFEM-Nessler reagent (the lower limit of measurement is 2 mcg for a 2 ml sample, which corresponds to the ammonium concentration 0.5 mg/m3).

The nitrogen oxide contents are determined by photocolorimetry on the reaction product of the GAFEM-Griss reagent (the lower measurement level is 0.3 mcg for a 2 ml sample, which corresponds to the nitrogen oxide concentration 0.075 mg/ m3).

The cyanide contents are determined by photocolorimetry on the reaction product thiocyanate (the lower measurement level is 2 mcg for a 5 ml sample, which corresponds to the cyanide concentration 0.1 mg/m3).

The results of the measurements are presented in the Table.

### EXAMPLE 2

To prepare 1 kg of the composition it is necessary to charge, with stirring, a mixer for viscousflow compositions with the following components: 140 g of 50% aqueous solution of sodium silicate, with the silicate fraction equal to 2.5. While stirring, at 100-300 rpm, to the mixture are added 900 g of basic carbonate with particle size 15-80 mcm in 50 g portions; 10 g of potassium nitrate with particle size 5-10 mcm; 2 g of calcium stearate; 2 g of graphite and 16 g of silica gel. After all the components have been added, the composition is mixed for 15-20 minutes until homogeneous pasty mass is formed. The resulting mass is passed to the formation operation on the hydraulic press by the continuous pressing method at room temperature and 50 MPa to obtain strings 8 mm in diameter, without a channel. The strings are then placed on a tray to dry out till the moisture content becomes 20-30% by mass. Then the strings are cut into cylindrical granules 6 mm in length. In order to remove water from the granules more completely, they are kept at 90-120 deg C. until the equilibrium moisture becomes ˜0.5 mass %. The ready granules are charged into the generator and tested as is described in Example 1. The results of the measurements are presented in the Table.

### INDUSTRIAL USE OF THE INVENTION

The proposed composition for cooling and filtration of GAFEM makes it possible to carry out efficient fire-fighting in structures, closed spaces and rooms, including where there are people, animals.

Advantages of the proposed composition are:
high efficiency of GAFEM cooling;
high fire-extinguishing efficiency of GAFEM;
high strength characteristics of tablets, granules;
high level of the GAFEM safety to the environment;

simplicity and safety of the composition production.

TABLE
Comparative characteristics of the claimed composition for cooling and simultaneous filtration
of the gas-aerosol fire-extinguishing mixture and the results of the tests.

| | | | | | | | | | | | | Composition of |
|---|---|---|---|---|---|---|---|---|---|---|---|---|
| Composition | Component ratios, percent by mass | | | | | | | | | | | prototype |
| components | 1 | 2 | 3 | 4 | 5 | 6 | 7 | 8 | 9 | 10 | 11 | RU 2166975 |
| Heat-absorbing | | | | | | | | | | | | |
| fillers | | | | | | | | | | | | |
| Basic magnesium | 80 | 90 | 90 | 60 | 36.5 | 25 | 30 | 40 | 89 | — | — | 30 |
| Carbonate | | | | | | | | | | | | |
| Magnesium | 5 | — | — | — | — | — | — | 14 | — | 50 | — | — |
| carbonate | | | | | | | | | | | | |
| Sodium | 5 | — | — | 25 | 40 | — | 5.0 | 10 | — | — | 50 | 7 |
| carbonate | | | | | | | | | | | | |
| Sodium | — | — | — | — | — | — | — | — | — | — | — | 15 |
| bicarbonate | | | | | | | | | | | | |
| Oxidizers | | | | | | | | | — | | | |
| Potassium nitrate | 0.5 | 1.0 | — | 3.0 | 10 | 10 | 4.0 | | 1.0 | 2.5 | — | — |
| Potassium | 0.5 | — | 1.0 | 5.0 | — | — | | | — | — | 2.5 | 25 |
| perchlorate | | | | | | | | | | | | |
| Magnesium oxide | — | — | — | — | — | — | — | — | — | — | — | 10 |
| Production | | | | | | | | | | | | |
| process | | | | | | | | | | | | |
| additives | | | | | | | | | | | | |
| Graphite | 0.5 | 0.2 | 0.2 | — | — | 0.1 | 0.5 | 0.4 | 0.2 | 0.1 | 0.1 | — |
| Calcium stearate | — | 0.2 | 0.2 | — | 0.75 | — | 0.5 | 0.6 | — | 0.4 | 0.4 | — |
| Sodium stearate | 0.5 | — | — | — | 0.75 | 0.1 | — | | — | — | — | 3 |
| Inorganic | | | | | | | | | | | | |
| binder | | | | | | | | | | | | |
| Potassium | 6 | — | — | 5 | 10 | 10 | 5 | 10 | 7.7 | — | — | — |
| chloride | | | | | | | | | | | | |
| Alkali metal | | | | | | | | | | | | |
| silicate: | — | 7.0 | — | — | — | — | 5 | — | — | 7.0 | 7.0 | — |
| Me = Na | — | — | 7.0 | — | — | — | — | — | — | — | — | — |
| Me = K | — | 2.2 | 3.8 | — | — | — | 2.7 | — | — | 2.2 | — | — |
| (Me₂O•mSiO₂) | | | | | | | | | | | | |
| Boric acid | — | — | — | — | — | — | — | — | — | — | — | 10 |
| Sorbent | | | | | | | | | | | | |
| Zeolite | 2 | — | — | 1.0 | 1.0 | 54.8 | — | 12.5 | 2.0 | — | — | — |
| Silica gel | — | 1.6 | 1.6 | 1.0 | 1.0 | — | 50 | 12.5 | — | 40 | 40 | — |

Comparative results of the tests

| | | | | | | | | | | | | |
|---|---|---|---|---|---|---|---|---|---|---|---|---|
| GAFEM | 115 | 120 | 125 | 140 | 160 | 180 | 190 | 145 | 125 | 190 | 180 | 210 |
| temperature at | | | | | | | | | | | | |
| the generator | | | | | | | | | | | | |
| outlet, deg C. | | | | | | | | | | | | |
| Efficiency | 13.04 | 12.5 | 12.0 | 10.71 | 9.37 | 8.82 | 7.89 | 10.34 | 12.0 | 7.9 | 8.8 | 6.42 |
| coefficient of | | | | | | | | | | | | |
| GAFEM cooling, | | | | | | | | | | | | |
| Cec | | | | | | | | | | | | |
| Strength, Mpa | 2.5 | 2.3 | 2.2 | 2.4 | 0.7 | 0.6 | 0.8 | 2.7 | 1.9 | 0.9 | 0.7 | 0.6 |
| Toxic gases | 0.2 | 0.33 | 0.27 | 0.25 | 0.23 | 0.21 | 0.22 | 0.30 | 0.28 | 0.27 | 0.30 | 1.4 |
| content: vol % | | | | | | | | | | | | |
| CO | 5 | 19.0 | 16.0 | 19.5 | 21.0 | 19.0 | 18.0 | 17.5 | 19.0 | 19.6 | 18.5 | — |
| Mg/M³ | 17.0 | 195 | 210 | 240 | 270 | 280 | 290 | 185 | 205 | 260 | 270 | — |
| NH₃ | | no | no | no | noτ | no | no | no | no | no | no | — |
| Mg/M³ | 180 | | | | | | | | | | | |
| NxOy | | | | | | | | | | | | |
| Mg/M³ | no | | | | | | | | | | | |
| HCN | | | | | | | | | | | | |
| 1-2 mcm particle | 65 | 70 | 68 | 67 | 55 | 54 | 54 | 69 | 64 | — | — | — |
| content of | | | | | | | | | | | | |
| aerosol, % | | | | | | | | | | | | |

1-2. (canceled)

3. A composition for cooling and simultaneous filtration of a gas-aerosol fire-extinguishing mixture comprising at least one heat-absorbing filler selected from basic magnesium carbonate, and carbonates of group I or II metals, at least one oxidizer selected from nitrate, potassium perchlorate and mixtures thereof, at least one production process additive selected from graphite, sodium stearate, calcium stearate and a mixture hereof, at least one inorganic binder selected from potassium chloride, alkali metal silicate of a general formula Me₂O.mSiO₂, where Me is potassium or sodium, m is a silicate variable in an amount of 2.1-3.8 and a mixture thereof, and a sorbent, in a following ratio, % by mass:
heat-absorbing filler −25-90
oxidizer −1-10
production process additive −0.2-1.5
inorganic binder −5-10
sorbent −remainder.

4. The composition for cooling and simultaneous filtration of the gas-aerosol fire-extinguishing mixture according to claim 3 wherein the sorbent is selected from a group consisting of zeolites, silica gels and a mixture thereof.

5. The composition of claim 3 wherein said mixture consists essentially of said filler, said oxidizer, said additive, said binder and said sorbent.

6. The composition of claim 4 wherein said mixture consists essentially of said filler, said oxidizer, said additive, said binder and said sorbent.

7. A composition for cooling and simultaneous filtration of a gas-aerosol fire-extinguishing mixture comprising at least one heat-absorbing filler selected from basic magnesium carbonate, and carbonates of group I or II metals, at least one oxidizer selected from nitrate, potassium perchlorate and mixtures thereof, at least one production process additive selected from graphite, sodium stearate, calcium stearate and a mixture hereof, at least one inorganic binder selected from potassium chloride, alkali metal silicate of a general formula Me₂O.mSiO₂, where Me is potassium or sodium, m is a silicate variable in an amount of 2.1-3.8 and a mixture thereof, and a sorbent selected from a group consisting of zeolites, silica gels and a mixture thereof, in a following ratio, % by mass:
heat-absorbing filler −25-90
oxidizer −1-10
production process additive −0.2-1.5
inorganic binder −5-10
sorbent −remainder.

8. A composition for cooling and simultaneous filtration of a gas-aerosol fire-extinguishing mixture consisting essentially of at least one heat-absorbing filler selected from basic magnesium carbonate, and carbonates of group I or II metals, at least one oxidizer selected from nitrate, potassium perchlorate and mixtures thereof, at least one production process additive selected from graphite, sodium stearate, calcium stearate and a mixture hereof, at least one inorganic binder selected from potassium chloride, alkali metal silicate of a general formula Me₂O.mSiO₂, where Me is potassium or sodium, m is a silicate variable in an amount of 2.1-3.8 and a mixture thereof, and a sorbent selected from a group consisting of zeolites, silica gels and a mixture thereof, in a following ratio, % by mass:
heat-absorbing filler −25-90
oxidizer −1-10
production process additive −0.2-1.5
inorganic binder −5-10
sorbent −remainder.
